(19) United States
(12) Patent Application Publication
(10) Pub. No.: US 2026/0154220 A1
(43) Pub. Date: Jun. 4, 2026

(54) MULTI-PROCESSOR SYSTEM AND METHOD FOR SETTING PORTS IN MULTI-PROCESSOR SYSTEM

(71) Applicant: MITAC COMPUTING TECHNOLOGY CORPORATION, Taoyuan City (TW)

(72) Inventors: Yen-Lun TSENG, Taoyuan City (TW); Kuan-Cheng LIN, Taoyuan City (TW); Ming-Heng LIU, Taoyuan City (TW)

(21) Appl. No.: 19/376,570

(22) Filed: Oct. 31, 2025

(30) Foreign Application Priority Data
Nov. 29, 2024 (TW) 113146260

(51) Int. Cl. G06F 13/362; G06F 13/16

(52) U.S. Cl. CPC G06F 13/362; G06F 13/1652

(57) ABSTRACT

A method for setting ports in a multi-processor system includes steps of: determining, based on a logic level at a reference pin of a master connector of the multi-processor system, whether the master connector and a slave connector of the multi-processor system are directly connected to each other; in response to determining that the master connector and the slave connector are directly connected to each other, setting a target G-port of a master processor of the multi-processor system and a target G-port of a slave processor of the multi-processor system to support External Global Memory Interconnect (xGMI); and in response to determining that the master connector and the slave connector are not directly connected to each other, setting the target G-port of the master processor and the target G-port of the slave processor to support Peripheral Component Interconnect Express (PCIe).

### CROSS-REFERENCE TO RELATED APPLICATION

This application claims priority to Taiwanese Invention Patent Application No. 113146260, filed on Nov. 29, 2024, the entire disclosure of which is incorporated by reference herein.

### FIELD

The disclosure relates to a multi-processor system and a method for setting ports in a multi-processor system.

### BACKGROUND

Typically, in a single-processor system architecture, the number of channels for Peripheral Component Interconnect Express (PCIe) is 128. These channels for PCIe are cooperatively formed by four G-ports and four P-ports of a single processor (e.g., a central processing unit, CPU). Particularly, each of the G-ports and the P-ports forms 16 channels (i.e., each of the G-ports forms 16 channels and each of the P-ports forms 16 channels).

Typically, in a multi-processor system architecture, it is necessary to set a part of ports of processors to support External Global Memory Interconnect (xGMI) so as to establish a communication interface between the processors and memory.

For example, referring to FIG. 1, a conventional multi-processor system is illustrated. The conventional multi-processor system includes two processors, and each of the processors has four G-ports (G0, G1, G2, G3) and four P-ports (P0, P1, P2, P3). The G-ports (G0, G1, G2, G3) and the P-ports (P0, P1, P2, P3) of each of the processors can be set in a first configuration as shown in the left part of FIG. 1, wherein the four G-ports (G0, G1, G2, G3) of each of the processors are set to support xGMI and the four P-ports (P0, P1, P2, P3) of each of the processors are set to support PCIe. However, in PCIe-demanding application where additional ports for PCIe are required, only four ports, i.e., the P-ports (P0, P1, P2, P3) of each of the processors, which are set to support PCIe in the first configuration, may not be enough to satisfy the requirement in this PCIe-demanding application. Alternatively, the G-ports (G0, G1, G2, G3) and the P-ports (P0, P1, P2, P3) of each of the processors can be set in a second configuration as shown in the right part of FIG. 1, wherein three of the four G-ports (G0, G1, G2, G3) of each of the processors are set to support xGMI, and the remaining one of the four G-ports (G0, G1, G2, G3) and the four P-ports (P0, P1, P2, P3) of each of the processors are set to support PCIe. However, in xGMI-demanding application where additional ports for xGMI are required, only three ports, i.e., the three of the G-ports (G0, G1, G2, G3) of each of the processors, which are set to support xGMI in the second configuration, may not be enough to satisfy the requirement in this xGMI-demanding application. That is to say, for flexibility, it would be beneficial to both of the PCIe-demanding application and the xGMI-demanding application when the G-ports (G0, G1, G2, G3) and the P-ports (P0, P1, P2, P3) of each of the processors could be arbitrarily set in one of the first configuration and the second configuration, depending on which one of the requirements respectively of the PCIe-demanding application and the xGMI-demanding application is required.

Conventionally, in order to arbitrarily set the G-ports (G0, G1, G2, G3) and the P-ports (P0, P1, P2, P3) of each of the processors in one of the first configuration and the second configuration, it is necessary to design and manufacture two versions of printed circuit boards (PCBs). It is worthy of note that material costs for manufacturing one PCB that supports PCI Express® 5.0 (PCIe Gen5) could be as high as several hundred dollars. Furthermore, if PCBs are made in mass production someday, additional costs of inventory and material preparation will be considerable expenses, which imposes a heavy burden on the enterprise manufacturing the PCBs.

### SUMMARY

Therefore, an object of the disclosure is to provide a multi-processor system and a method for setting ports in a multi-processor system that can alleviate at least one of the drawbacks of the prior art.

According to one aspect of the disclosure, the multi-processor system includes a master processor, a slave processor, a master connector and a slave connector.

The master processor has a target G-port that is electrically connected to the master connector. The master connector has a reference pin that is electrically connected to the master processor. The slave processor is electrically connected to the master processor, and has a target G-port that is electrically connected to the slave connector.

The master processor is configured to determine, based on a logic level at the reference pin of the master connector, whether the master connector and the slave connector are directly connected to each other. In response to determining that the master connector and the slave connector are directly connected to each other, the master processor is configured to set the target G-port of the master processor and the target G-port of the slave processor to support External Global Memory Interconnect (xGMI) automatically. In response to determining that the master connector and the slave connector are not directly connected to each other, the master processor is configured to set the target G-port of the master processor to support Peripheral Component Interconnect Express (PCIe) automatically.

The slave processor is configured to set the target G-port of the slave processor to support PCIe in response to the master processor determining that the master connector and the slave connector are not directly connected to each other.

According to another aspect of the disclosure, the method is to be implemented by the multi-processor system that is previously described, and includes steps of:
determining, based on a logic level at the reference pin of the master connector, whether the master connector and the slave connector are directly connected to each other;
in response to determining that the master connector and the slave connector are directly connected to each other, setting the target G-port of the master processor and the target G-port of the slave processor to support xGMI; and
in response to determining that the master connector and the slave connector are not directly connected to each other, setting the target G-port of the master processor and the target G-port of the slave processor to support PCIe.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating a conventional multi-processor system having ports that can be set in two configurations.

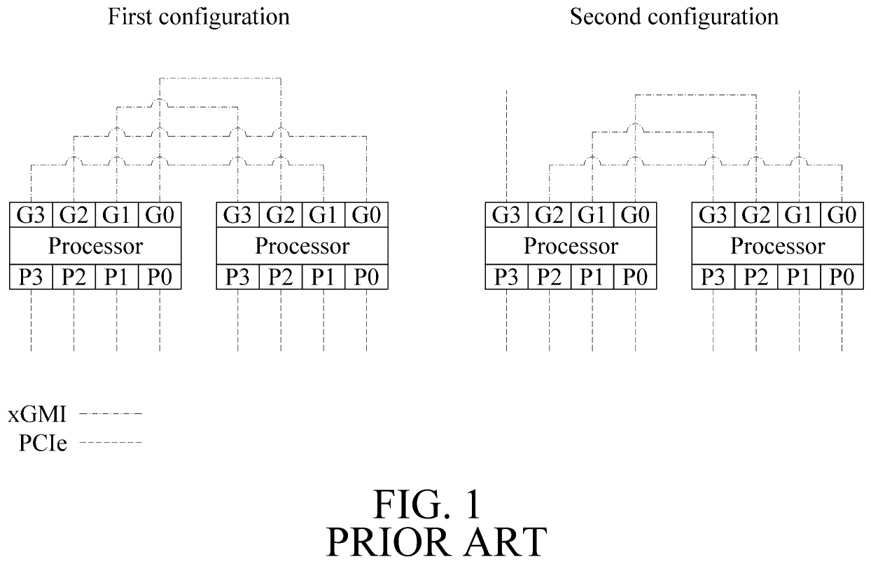

FIG. 2 is a schematic diagram illustrating a multi-processor system according to an embodiment of the disclosure.

FIG. 3 is a flow chart illustrating a method for setting ports in the multi-processor system according to an embodiment of the disclosure.

### DETAILED DESCRIPTION

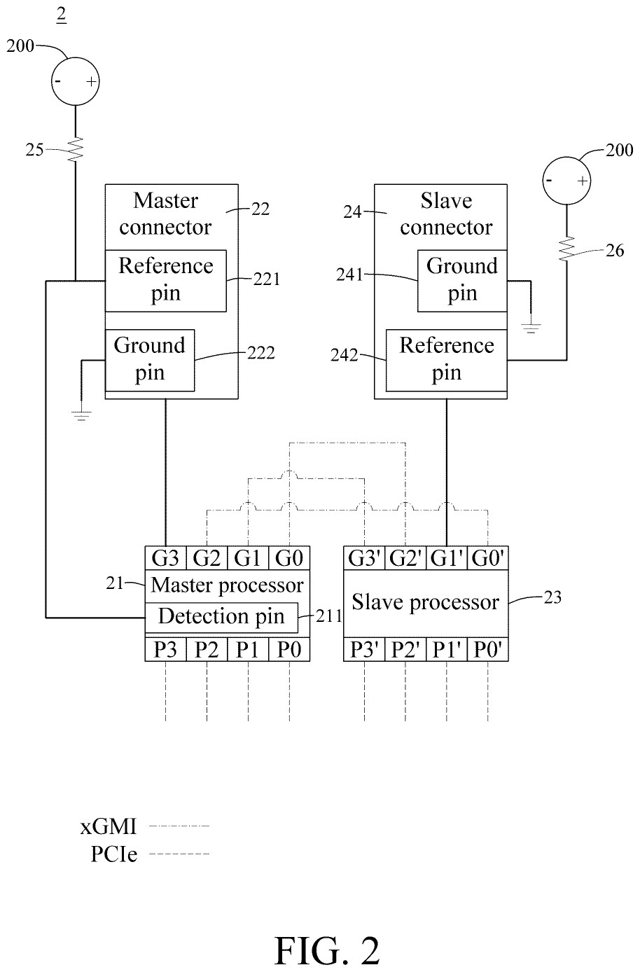

Referring to FIG. 2, an embodiment of a multi-processor system 2 according to the disclosure is illustrated. The multi-processor system 2 includes a master processor 21, a slave processor 23, a master connector 22, a slave connector 24, a first pulled-up resistor 25, a second pulled-up resistor 26 and a power supply 200.

The power supply 200 is configured to output voltage that is exemplarily 3.3 Volt, but is not limited thereto.

The master processor 21 includes multiple P-ports (P0, P1, P2, P3), and multiple G-ports (G0, G1, G2, G3) that include a target G-port (G3) of the master processor 21. The slave processor 23 has multiple P-ports (P0′, P1′, P2′, P3′), and multiple G-ports (G0′, G1′, G2′, G3′) that include a target G-port (G1′) of the slave processor 23. The G-port (G0) of the master processor 21 is electrically connected to the G-port (G2′) of the slave processor 23. The G-port (G1) of the master processor 21 is electrically connected to the G-port (G3′) of the slave processor 23. The G-port (G2) of the master processor 21 is electrically connected to the G-port (G0′) of the slave processor 23. The target G-port (G3) of the master processor 21 is electrically connected to the master connector 22. The target G-port (G1′) of the slave processor 23 is electrically connected to the slave connector 24. In some cases, the master processor 21 and the slave processor 23 are both electrically connected to a common peripheral device (not shown) via the P-ports (P0, P1, P2, P3) of the master processor 21 and the P-ports (P0′, P1′, P2′, P3′) of the slave processor 23. The common peripheral device may be implemented to be system memory (e.g., random-access memory, RAM), a graphics processing unit (GPU) and so on, but is not limited thereto. In some cases, the master processor 21 is electrically connected to a first peripheral device (not shown) via the P-ports (P0, P1, P2, P3) of the master processor 21, and the slave processor 23 is electrically connected to a second peripheral device (not shown) via the P-ports (P0′, P1′, P2′, P3′) of the slave processor 23. Each of the first peripheral device and the second peripheral device may be implemented to be a solid-state drive (SSD), a graphics card, a sound card, a network card and so on, but is not limited thereto.

The master connector 22 has a reference pin 221 and a ground pin 222. The ground pin 222 of the master connector 22 is grounded. The first pulled-up resistor 25 has two opposite ends, one of which is electrically connected to the power supply 200 and another of which is electrically connected to the reference pin 221 of the master connector 22. The reference pin 221 of the master connector 22 may be implemented by any available pin of the master connector 22.

The slave connector 24 has a ground pin 241 and a reference pin 242. The ground pin 241 of the slave connector 24 is grounded. The second pulled-up resistor 26 has two opposite ends, one of which is electrically connected to the power supply 200 and another of which is electrically connected to the reference pin 242 of the slave connector 24. The reference pin 242 of the slave connector 24 may be implemented by any available pin of the slave connector 24.

The master connector 22 and the slave connector 24 are configured to be electrically connected to each other through two electrical connections (not shown), one of which is between the reference pin 221 of the master connector 22 and the ground pin 241 of the slave connector 24 and another of which is between the ground pin 222 of the master connector 22 and the reference pin 242 of the slave connector 24. The aforesaid electrical connections may be implemented by using a high-speed cable such as a MCIO (Mini Cool Edge IO) cable, but are not limited thereto. For example, the aforesaid electrical connections may be implemented by using a NearStack connector in some embodiments. Since the MCIO cable has been well known to one skilled in the relevant art, detailed explanation of the same is omitted herein for the sake of brevity. In this way, a logic level (which is represented by voltage) at the reference pin 221 of the master connector 22 becomes logic low when the master connector 22 and the slave connector 24 are directly connected to each other, and the logic level at the reference pin 221 of the master connector 22 becomes logic high when the master connector 22 and the slave connector 24 are not directly connected to each other. It is worthy of note that the first pulled-up resistor 25 is utilized to ensure that the logic level at the reference pin 221 of the master connector 22 would be kept at logic high when the master connector 22 and the slave connector 24 are not directly connected to each other. The master processor 21 further has a detection pin 211 that is electrically connected to the reference pin 221 of the master connector 22 for allowing the master processor 21 to determine the logic level at the reference pin 221 of the master connector 22. It should be noted that the detection pin 211 of the master processor 21 may be implemented by a general-purpose input/output (GPIO) pin. Since implementation of detecting the logic level by using the GPIO pin has been well known to one skilled in the relevant art, detailed explanation of the same is omitted herein for the sake of brevity.

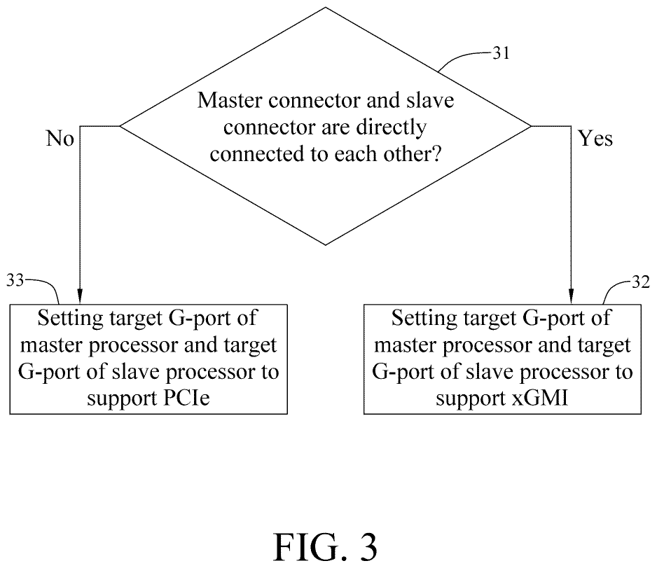

Referring to FIG. 3, an embodiment of a method for setting ports in the multi-processor system 2 according to the disclosure is illustrated. The method is to be implemented by the multi-processor system 2 that is previously described. The method includes steps 31 to 33 delineated below.

In step 31, the master processor 21 determines, based on the logic level at the reference pin 221 of the master connector 22, whether the master connector 22 and the slave connector 24 are directly connected to each other. Specifically, the master processor 21 determines whether the master connector 22 and the slave connector 24 are directly connected to each other by determining whether the logic level at the reference pin 221 of the master connector 22 is logic low. In response to determining that the master connector 22 and the slave connector 24 are directly connected to each other, i.e., the master processor 21 determines that the logic level at the reference pin 221 of the master connector 22 is logic low, a procedure flow of the method proceeds to step 32. Otherwise, in response to determining that the master connector 22 and the slave connector 24 are not directly connected to each other, i.e., the master processor 21 determines that the logic level at the reference pin 221 of the master connector 22 is not logic low, the procedure flow proceeds to step 33.

In step 32, the master processor 21 sets the target G-port (G3) of the master processor 21 and the target G-port (G1′) of the slave processor 23 to support External Global Memory Interconnect (xGMI). Specifically, the master processor 21 sets the P-ports (P0, P1, P2, P3) and the G-ports (G0, G1, G2, G3) of the master processor 21 in a 4G configuration, and sends a notification via an inter-processor communication interface (not shown) to the slave processor 23 for enabling the slave processor 23 to set the P-ports (P0′, P1′, P2′, P3′) and the G-ports (G0′, G1′, G2′, G3′) thereof in the 4G configuration. In response to receipt of the notification, the slave processor 23 sets the P-ports (P0′, P1′, P2′, P3′) and the G-ports (G0′, G1′, G2′, G3′) of the slave processor 23 in the 4G configuration, such that the G-ports (G0, G1, G2, G3) and the P-ports (P0, P1, P2, P3) of the master processor 21 and the G-ports (G0′, G1′, G2′, G3′) and the P-ports (P0′, P1′, P2′, P3′) of the slave processor 23 cooperatively form a set of transmitting channels for transmitting data to the common peripheral device and a set of receiving channels for receiving data from the common peripheral device. The set of transmitting channels allows the master processor 21 to transmit data to the common peripheral device through the P-ports (P0, P1, P2, P3) thereof and to the slave processor 23 through the G-ports (G0, G1, G2, G3) thereof, and allows the slave processor 23 to transmit the data received from the master processor 21 to the common peripheral device through the P-ports (P0′, P1′, P2′, P3′) thereof. The set of receiving channels allows the slave processor 23 to receive data from the common peripheral device through the P-ports (P0′, P1′, P2′, P3′) thereof, and allows the master processor 21 to receive data from the common peripheral device through the P-ports (P0, P1, P2, P3) thereof, and to receive the data received by the slave processor 23 from the common peripheral device through the G-ports (G0, G1, G2, G3) thereof. By virtue of using the set of transmitting channels and the set of receiving channels, the common peripheral device has a relatively wide bandwidth.

In step 33, the master processor 21 sets the target G-port (G3) of the master processor 21 to support Peripheral Component Interconnect Express (PCIe), and the slave processor 23 sets the target G-port (G1′) of the slave processor 23 to support PCIe. Specifically, the master processor 21 sets the P-ports (P0, P1, P2, P3) and the G-ports (G0, G1, G2, G3) of the master processor 21 in a 3G configuration, wherein the P-ports (P0, P1, P2, P3) of the master processor 21 are set to form a set of transmitting-receiving channels for transmitting data to the first peripheral device and receiving data from the first peripheral device. Similarly, the slave processor 23 sets the P-ports (P0′, P1′, P2′, P3′) and the G-ports (G0′, G1′, G2′, G3′) of the slave processor 23 in the 3G configuration, wherein the P-ports (P0′, P1′, P2′, P3′) of the slave processor 23 are set to form a set of transmitting-receiving channels for transmitting data to the second peripheral device and receiving data from the second peripheral device. In some embodiments, the master processor 21 receives first operation data via the target G-port (G3) of the master processor 21, and operates the first peripheral device via the P-ports (P0, P1, P2, P3) of the master processor 21 based on the first operation data thus received; the slave processor 23 receives second operation data via the target G-port (G1′) of the slave processor 23, and operates the second peripheral device via the P-ports (P0′, P1′, P2′, P3′) of the slave processor 23 based on the second operation data thus received. In some embodiments where a first external device (e.g., an SSD, a GPU and so on) is electrically connected to the master connector 22 and a second external device (e.g., an SSD, a GPU and so on) is electrically connected to the slave connector 24, the master processor 21 receives third operation data from the first peripheral device via the P-ports (P0, P1, P2, P3) of the master processor 21, and transmits the first operation data thus received through the master connector 22 to the first external device via the target G-port (G3) of the master processor 21 for communicating with the first external device; the slave processor 23 receives fourth operation data from the second peripheral device via the P-ports (P0′, P1′, P2′, P3′) of the slave processor 23, and transmits the fourth operation data thus received through the slave connector 24 to the second external device via the target G-port (G1′) of the slave processor 23 for communicating with the second external device. That is to say, the master processor 21 and the slave processor 23 communicate respectively and independently with the first peripheral device and the second peripheral device, and operate the first peripheral device and the second peripheral device, respectively and independently.

In one embodiment, in a booting process, while the master processor 21 determines that the master connector 22 and the slave connector 24 are not directly connected to each other and sets the P-ports (P0, P1, P2, P3) and the G-ports (G0, G1, G2, G3) of the master processor 21 in the 3G configuration, the master processor 21 would notify, via the inter-processor communication interface (not shown), the slave processor 23 to enable the slave processor 23 to set the P-ports (P0′, P1′, P2′, P3′) and the G-ports (G0′, G1′, G2′, G3′) of the slave processor 23 in the 3G configuration.

In one embodiment, while the master processor 21 determines that the master connector 22 and the slave connector 24 are not directly connected to each other and sets the P-ports (P0, P1, P2, P3) and the G-ports (G0, G1, G2, G3) of the master processor 21 in the 3G configuration, the slave processor 23 would not be notified by the master processor 21, and the slave processor 23 automatically sets, a while after the multi-processor system 2 has been started, the P-ports (P0′, P1′, P2′, P3′) and the G-ports (G0′, G1′, G2′, G3′) of the slave processor 23 in the 3G configuration by default.

To sum up, in the multi-processor system 2 and the method for setting ports in the multi-processor system 2 according to the disclosure, the master connector 22 is electrically connected to the target G-port (G3) of the master processor 21, and the slave connector 24 is electrically connected to the target G-port (G1′) of the slave processor 23. In addition, the logic level at the reference pin 221 of the master connector 22 is logic low when the master connector 22 and the slave connector 24 are directly connected to each other, and the logic level at the reference pin 221 of the master connector 22 is logic high when the master connector 22 and the slave connector 24 are not directly connected to each other. When the logic level at the reference pin 221 of the master connector 22 is logic low, i.e., the master connector 22 and the slave connector 24 are directly connected to each other, the target G-port (G3) of the master processor 21 and the target G-port (G1′) of the slave processor 23 will be set to support xGMI. On the other hand, when the logic level at the reference pin 221 of the master connector 22 is logic high, i.e., the master connector 22 and the slave connector 24 are not directly connected to each other, the target G-port (G3) of the master processor 21 and the target G-port (G1′) of the slave processor 23 will be set to support PCIe. In this way, a single version of printed circuit boards (PCB) is enough to support two different configurations (i.e., the 3G configuration and the 4G configuration) of the P-ports and the G-ports of each of the master processor 21 and the slave processor 23, thereby satisfying different requirements regarding the numbers of ports for xGMI and PCIe. Furthermore, costs of manufacturing PCBs may be reduced.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for setting ports in a multi-processor system, the multi-processor system including a master processor, a slave processor, a master connector and a slave connector, the master processor having a target G-port that is electrically connected to the master connector, the master connector having a reference pin that is electrically connected to the master processor, the slave processor being electrically connected to the master processor and having a target G-port that is electrically connected to the slave connector, the method comprising steps of:
determining, based on a logic level at the reference pin of the master connector, whether the master connector and the slave connector are directly connected to each other;
in response to determining that the master connector and the slave connector are directly connected to each other, setting the target G-port of the master processor and the target G-port of the slave processor to support External Global Memory Interconnect (xGMI); and
in response to determining that the master connector and the slave connector are not directly connected to each other, setting the target G-port of the master processor and the target G-port of the slave processor to support Peripheral Component Interconnect Express (PCIe).

2. The method as claimed in claim 1, wherein, in the step of determining whether the master connector and the slave connector are directly connected to each other:
the master processor determining whether the master connector and the slave connector are directly connected to each other is implemented by determining whether the logic level at the reference pin of the master connector is logic low;
the master processor determining that the master connector and the slave connector are directly connected to each other in response to determining that the logic level at the reference pin of the master connector is logic low; and
the master processor determining that the master connector and the slave connector are not directly connected to each other in response to determining that the logic level at the reference pin of the master connector is not logic low.

3. The method as claimed in claim 1, wherein the step of setting the target G-port of the master processor and the target G-port of the slave processor to support xGMI includes the master processor setting the target G-port thereof in a 4G configuration, and sending a notification to the slave processor for the slave processor to set the target G-port thereof in the 4G configuration.

4. The method as claimed in claim 3, the master processor further having multiple P-ports, and multiple G-ports that includes the target G-port thereof, the slave processor further having multiple P-ports, and multiple G-ports that includes the target G-port thereof, the master processor and the slave processor being both electrically connected to a common peripheral device via the P-ports of the master processor and the P-ports of the slave processor, wherein the step of setting the target G-port of the master processor and the target G-port of the slave processor to support xGMI further includes:
the master processor further setting the P-ports and the G-ports of the master processor in the 4G configuration, and, in response to receipt of the notification, the slave processor setting the P-ports and the G-ports of the slave processor in the 4G configuration, such that the G-ports and the P-ports of the master processor and the G-ports and the P-ports of the slave processor cooperatively form a set of transmitting channels for transmitting data to the common peripheral device and a set of receiving channels for receiving data from the common peripheral device.

5. The method as claimed in claim 4, wherein:
the set of transmitting channels allows the master processor to transmit data to the common peripheral device through the P-ports thereof and to the slave processor through the G-ports thereof, and allows the slave processor to transmit the data received from the master processor to the common peripheral device through the P-ports thereof; and
the set of receiving channels allows the slave processor to receive data from the common peripheral device through the P-ports thereof, and allows the master processor to receive data from the common peripheral device through the P-ports thereof, and to receive the data received by the slave processor from the common peripheral device through the G-ports thereof.

6. The method as claimed in claim 1, wherein the step of setting the target G-port of the master processor and the target G-port of the slave processor to support PCIe includes the master processor setting the target G-port of the master processor in a 3G configuration, and the slave processor setting the target G-port of the slave processor in the 3G configuration.

7. The method as claimed in claim 6, the master processor further having multiple P-ports and being further electrically connected to a first peripheral device via the P-ports of the master processor, the slave processor further having multiple P-ports and being further electrically connected to a second peripheral device via the P-ports of the slave processor, wherein the step of setting the target G-port of the master processor and the target G-port of the slave processor to support PCIe further includes:
the master processor setting the P-ports of said master processor to form a set of transmitting-receiving channels for transmitting data to the first peripheral device and receiving data from the first peripheral device; and
the slave processor setting the P-ports of the slave processor to form a set of transmitting-receiving channels for transmitting data to the second peripheral device and receiving data from the second peripheral device.

8. A multi-processor system comprising:
a master processor;
a slave processor;
a master connector; and
a slave connector,
wherein said master processor has a target G-port that is electrically connected to said master connector,
wherein said master connector has a reference pin that is electrically connected to said master processor,
wherein said slave processor is electrically connected to said master processor and has a target G-port that is electrically connected to said slave connector,
wherein said master processor is configured to
determine, based on a logic level at said reference pin of said master connector, whether said master connector and said slave connector are directly connected to each other,
in response to determining that said master connector and said slave connector are directly connected to each other, set said target G-port of said master processor and said target G-port of said slave processor to support External Global Memory Interconnect (xGMI), and
in response to determining that said master connector and said slave connector are not directly connected to each other, set said target G-port of said master processor to support Peripheral Component Interconnect Express (PCIe), and
wherein said slave processor is configured to set said target G-port of said slave processor to support PCIe in response to said master processor determining that said master connector and said slave connector are not directly connected to each other.

9. The multi-processor system as claimed in claim 8, wherein said master processor is configured to:
determine whether said master connector and said slave connector are directly connected to each other by determining whether the logic level at said reference pin of said master connector is logic low;
determine that said master connector and said slave connector are directly connected to each other in response to determining that the logic level at said reference pin of said master connector is logic low; and
determine that said master connector and said slave connector are not directly connected to each other in response to determining that the logic level at said reference pin of said master connector is not logic low.

10. The multi-processor system as claimed in claim 9, further comprising a pulled-up resistor and a power supply, wherein:
said pulled-up resistor has two opposite ends, one of which is electrically connected to said power supply and another of which is electrically connected to said reference pin of said master connector;
said slave connector has a ground pin that is grounded;
said master connector and said slave connector are configured to be electrically connected to each other through an electrical connection between said reference pin of said master connector and said ground pin of said slave connector; and
said master processor further has a detection pin that is electrically connected to said reference pin of said master connector for allowing said master processor to determine the logic level at said reference pin of said master connector.

11. The multi-processor system as claimed in claim 8, wherein said master processor is configured to set said target G-port thereof in a 4G configuration, and to send a notification to said slave processor for said slave processor to set said target G-port thereof in the 4G configuration.

12. The multi-processor system as claimed in claim 11, wherein:
said master processor further has multiple P-ports, and multiple G-ports that includes said target G-port thereof;
said slave processor further has multiple P-ports, and multiple G-ports that includes said target G-port thereof;
said master processor and said slave processor are both electrically connected to a common peripheral device via said P-ports of said master processor and said P-ports of said slave processor; and
said master processor is further configured to set said P-ports and said G-ports of said master processor in the 4G configuration, and in response to receipt of the notification, said slave processor is further configured to set said P-ports and said G-ports of said slave processor in the 4G configuration, such that said G-ports and said P-ports of said master processor and said G-ports and said P-ports of said slave processor cooperatively form a set of transmitting channels for transmitting data to the common peripheral device and a set of receiving channels for receiving data from the common peripheral device.

13. The multi-processor system as claimed in claim 12, wherein:
the set of transmitting channels allows said master processor to transmit data to the common peripheral device through said P-ports thereof and to said slave processor through said G-ports thereof, and allows said slave processor to transmit the data received from said master processor to the common peripheral device through said P-ports thereof; and
the set of receiving channels allows said slave processor to receive data from the common peripheral device through said P-ports thereof, and allows said master processor to receive data from the common peripheral device through said P-ports thereof, and to receive the data received by said slave processor from the common peripheral device through said G-ports thereof.

14. The multi-processor system as claimed in claim 8, wherein said master processor is configured to set said target G-port of said master processor in a 3G configuration, and said slave processor is configured to set said target G-port of said slave processor in the 3G configuration.

15. The multi-processor system as claimed in claim 14, wherein:
said master processor further has multiple P-ports, and is further electrically connected to a first peripheral device via said P-ports of said master processor;
said slave processor further has multiple P-ports, and is further electrically connected to a second peripheral device via said P-ports of said slave processor;
said master processor is configured to set said P-ports of said master processor to form a set of transmitting-receiving channels for transmitting data to the first peripheral device and receiving data from the first peripheral device; and
said slave processor is configured to set said P-ports of said slave processor to form a set of transmitting-receiving channels for transmitting data to the second peripheral device and receiving data from the second peripheral device.
